(19) United States
(12) Patent Application Publication
(10) Pub. No.: US 2026/0257350 A1
(43) Pub. Date: Sep. 3, 2026

(54) DEEP DYNAMIC GRAPH NEURAL NETWORKS FOR EXPLAINABLE INTENTION ESTIMATION

(71) Applicant: Honda Motor Co., Ltd., Tokyo (JP)

(72) Inventors: Prakash BASKARAN, San Jose, CA (US); Xiao LIU, San Clara, CA (US); Songpo LI, San Jose, CA (US); Soshi IBA, Mountain View, CA (US)

(73) Assignee: Honda Motor Co., Ltd., Tokyo (JP)

(21) Appl. No.: 19/222,685

(22) Filed: May 29, 2025

Related U.S. Application Data
(60) Provisional application No. 63/765,883, filed on Mar. 3, 2025.

(51) Int. Cl. B25J 9/16

(52) U.S. Cl. CPC B25J 9/163; B25J 9/161

(57) ABSTRACT

A method for intention estimation in robot teleoperation tasks is provided. The method may generate dynamic graphs that show spatial relationships over time to predict user intentions for short-horizontal actions and long-horizon tasks.

### RELATED APPLICATIONS

This patent application is related to U.S. Provisional Application No. 63/765,883 filed Mar. 3, 2025, entitled “DEEP DYNAMIC GRAPH NEURAL NETWORKS FOR EXPLAINABLE INTENTION ESTIMATION”, in the names of the same inventors and which is incorporated herein by reference in its entirety. The present patent application claims the benefit under 35 U.S.C § 119(e) of the aforementioned provisional application.

### BACKGROUND

Bi-manual robot teleoperation may involve controlling a robotic system with two manipulators using both hands. This approach may typically be required in scenarios where complex manipulation may be necessary, but direct human interaction may be impractical. Examples of where bi-manual robot teleoperation may be used are in situations such as surgery, space exploration, hazardous environments, and other similar situations. However, teleoperation robotic systems may typically be designed for mechanical efficiency over biological mimicry, and their inherent perception and execution latencies may cause synchronization and coordination issues, which may lead to poor manipulation. These teleoperational difficulties may challenge non-experts, making it difficult for them to operate the robotic system effectively.

Shared autonomy may intend to solve this complex teleoperation process by distributing control between the human operator and the robot. This approach may combine the strength of human decision-making (e.g., awareness, adaptability, dexterity) with the capabilities of autonomous robotic systems (e.g., intelligence, speed, precision, and scalability). A key aspect of achieving seamless collaboration and building trust in shared autonomy may be the robot's ability to interpret the human's intentions and performance in a consistent and explainable manner. This understanding may enable the robot to provide effective assistance and explain the rationale behind the assistance provided.

Existing research on human intention estimation may primarily focus on predicting short-horizon actions and targets; however, it may be necessary to know the long-horizon task to generate proper assistance for the current action. Furthermore, it may be important not only to predict long-horizon tasks, but also to anchor the long-horizon tasks in a logical framework for transparent and effective assistance. Such a framework may serve as a condensed knowledge source to encode vital scene information, which may be utilized for complex downstream teleoperation processes (e.g., target prediction, planning, and trajectory generation).

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for intention estimation in a robot teleoperation task is provided. The method may generate dynamic graphs that show spatial relationships over time to predict user intentions for short-horizontal actions and long-horizon tasks.

According to an embodiment of the disclosure, a method for intention estimation in a robot teleoperation task is provided. The method may encode end effector data of a robot performing the teleoperation tasks and object poses of the teleoperation tasks. The method may generate dynamic graphs by processing the end effector data and object poses to show spatial relationships over time to predict user intentions for short-horizontal actions of a next step and long-horizon task of multiple steps/actions in a specific order over a predetermined period to reach a predetermined objective using a heuristic graph neural network (GNN) to model dynamic spatial object relationships between objects using pre-defined rules and using a learned GNN for generating the spatial relationships for long-horizon tasks.

According to an embodiment of the disclosure, a method for intention estimation in robot teleoperation tasks, the method implemented using a computer system including a processor communicatively coupled to a memory device is provided. The method may encode end effector data of a robot performing the teleoperation tasks and object poses of the teleoperation tasks. The method may process the end effector data and object poses by graph neural networks (GNNs) generating dynamic graphs that show spatial relationships over time to predict user intentions for short-horizontal actions and long-horizon tasks, wherein the end effector data and the object poses are encoded separately. The method may partition learned features from the dynamic graphs into multiple channels for the intention estimation.

### BRIEF DESCRIPTION OF THE DRAWINGS

FIGS. 1A-1B depict an exemplary teleoperated assembly task using a robotic arm system having an intention estimation framework in accordance with an embodiment of the disclosure;

FIGS. 2A-2H depict exemplary toy assembly tasks used for training the intention estimation framework in accordance with an embodiment of the disclosure;

FIG. 3 shows an exemplary chart showing the intention estimation framework in accordance with an embodiment of the disclosure;

FIGS. 4A-4F depict steps for an exemplary toy assembly task where a pretrained action recognition module of the intention estimation framework is deployed in accordance with an embodiment of the disclosure;

FIGS. 5A-5D show exemplary diagrams depicting normalized action prediction confusion matrices across deep dynamic graph (DDG) models in accordance with an embodiment of the disclosure;

FIGS. 6A-6B show exemplary diagrams depicting normalized multi-label task prediction confusion matrices across the DDG models in accordance with an embodiment of the disclosure;

FIGS. 7A-7F show exemplary charts depicting frequency adjacency matrix representing the block connections and visualization of the ranking of the most frequently occurring block connections in accordance with an embodiment of the disclosure;

FIG. 8 shows an exemplary chart depicting evaluation of the continuity of L-DDG explanations across five distinct training seeds in accordance with an embodiment of the disclosure; and

FIGS. 9A-9E show exemplary charts depicting learned “anchor relationships” during block assembly with the placement of two and three blocks in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

The present system and method may introduce an intention estimation framework that employs graph neural networks (GNNs) to model the dynamic spatial relationships among manipulated objects during teleoperation. Capturing these spatial relationships may provide temporal logic to understand long-term intentions, which may be particularly useful when the manipulated objects may be identical and interchangeable. This spatial relationship may also provide a basis for explaining the algorithm's predictions, thereby improving the trust and collaboration between the robotic system and teleoperators.

The present system and method may predict human intentions at two hierarchical levels simultaneously: i) short-horizon actions, and ii) long-horizon tasks. The predictions may be derived from a knowledge source (i.e., graph) which may be designed to capture the dynamic spatial relationships in a consistent and explainable manner. The present system and method may have three unique contributions: (1) a heuristic GNN for intention estimation that may model the dynamic spatial object relationships between the objects using pre-defined rules; (2) a learned GNN, where the network may be refined to autonomously generate the underlying spatial relationships (i.e., graph connections), enabling task-agnostic intention estimation; and (3) a systematic method which may evaluate the graph's learned spatial relationships, using both empirical and anecdotal evidence, with explainability metrics.

Research aimed at advancing shared autonomy in teleoperation may primarily address two challenges: predicting the operator's intent during task execution and determining the assistance required to complete the task efficiently. Existing studies on intention estimation may generally predict a distribution of possible action targets using machine learning models. These models may typically incorporate robot motion features (e.g., end-effector pose, velocity, and joint angles), or human behavioral observations (e.g., human arm trajectories, gestures, and gazes) as input to predict the intent. Once the operator's intentions are inferred, cooperative motion planners and learning-based policies derived from demonstrations may be applied to provide assistance. Some studies may integrate intention estimation and assistance generation by directly producing trajectory plans and robot control commands based on human actions. These research studies may define human intention estimation as inferring the operator's desired limb trajectory, and may often employ neural networks to estimate the trajectory, while other studies may apply long-short term memory networks to predict human intention based on the human limb dynamics.

Hidden Markov models have been used to analyze discrete sets of tasks or subtasks for intention estimation. However, these studies may typically focus on single-layer representations, whereas human intention may often involve a multilayer hierarchical structure. Hierarchical hidden Markov models have also been explored for multi-layer classifications. While these approaches may infer probability distributions over intentions using dynamic programming, this method may be computationally expensive for real-time performance, especially with rich and long sequential observations, and it may increase the complexity of modeling. Neural networks have gained significant popularity in robotics and may be used to predict human intentions from time-series data.

A few existing works may have designed hierarchical networks based on topological properties of graphical task representations. One study may have introduced a deep learning model with a layer dependency loss function to represent the task hierarchy, while others may have employed probabilistic programming approaches to capture the task hierarchy. Most of these studies have adopted a one-dimensional approach, which may focus solely on predicting short-term actions (e.g., fine-grained motions), while neglecting the operator's long-term goals (e.g., coarse tasks). Furthermore, these studies may not account for how the manipulated objects' relationship with each other evolves over time, which may be essential for accurately predicting long-horizon tasks and providing effective assistance.

Recently, there has been growing interest in explainable robotic systems that may perform tasks effectively, while providing human-like reasoning. Reward decomposition to reason robot decision-making may have been explored for human-robot collaboration tasks, while other studies may have focused on predicting failure modes for manipulation via white-box model comparisons, or may have employed hierarchical, explainable logical graphs to build robot policy network. Similarly, a graph-based world model for identifying key nodes and their reachability may have been introduced to improve action planning. The proposed deep dynamic graph neural network may identify critical spatial relationships for human intention estimation, and may substantiate their reasoning via established explainability metrics.

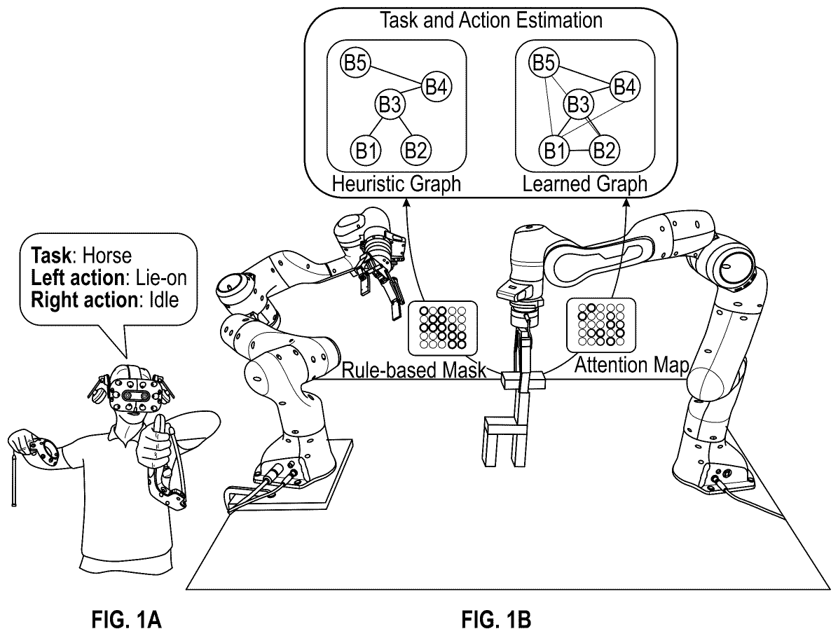

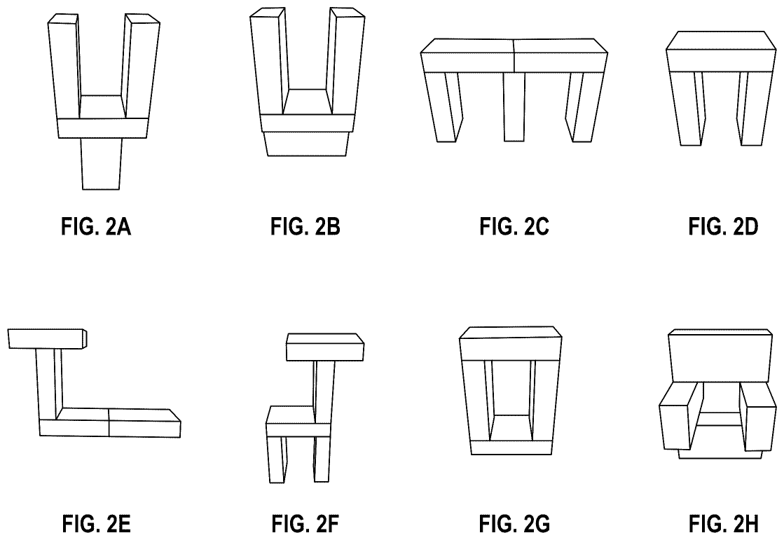

A human operator may teleoperate a bi-manual robotic platform in simulation as shown in FIG. 1 to complete a set of m block assembly tasks as may be seen in FIG. 2 and may be denoted as T. The human teleoperator may perform a series of actions (e.g., pick-up, stand-on-floor, stand-on-block, lie-on-floor, etc.) from the action set, and may be denoted as A, to complete a particular block assembly task. The human intention at time-step t may be defined as

$${H}_{t} = ( {T}_{t} , {a}_{t}^{l} , {a}_{t}^{r} ) , where {T}_{t} ∈ 𝒯 , {a}_{t}^{l} ∈ A , and {a}_{t}^{r} ∈ A$$

may represent the block assembly task, left-hand action, and right-hand action performed at time t, respectively. Modern sensor equipment may provide access to the online observation history X_{1:t}∈R^{t×F}, which may include data relevant to intention estimation (e.g., human-robot motion features, block objects' pose information, video feeds from surrounding cameras, egocentric views, and gaze information). F may represent the dimensionality of the input features. For seamless teleoperation, it may be important to continuously capture the teleoperator's intentions in real-time and offer autonomous shared control as assistance.

Using the entire observation history X_{1:t} as input may introduce irrelevant past information to the model; therefore, a fixed-size sliding window may be applied to segment the most recent sensor observation from the time-series data as input to the model. Thus, the dataloader may generate X∈R^{LxF}=X_{t-L:t} as input, and the corresponding ground truth human intention

$${H}_{t - L : t} := ( {T}_{t} - L : t , {a}_{t - L : t}^{l} , {a}_{t - L : t}^{r} ) ,$$

where L may denote the selected window size. The graph neural network model may take the objects' and the robots' end-effector pose (position and quaternion), as well as the end-effectors' linear and angular velocities as input.

$${X}_{t - L : t} := [ p , v ] , p ∈ {R}^{L \times ( 2 + B ) * 7} , v ∈ {R}^{L \times 2 * 6}$$

where B=5 may denote the total number of block objects, p may denote the pose of the end-effector and blocks, and v may denote the left and right end-effector's linear and angular velocities. The left

$$( {a}_{t - L : t}^{l} ) and right ( {a}_{t - L : t}^{r} )$$

hand activities may be labeled separately by selecting the activity that occurred most frequently within the window and may be given by:

$${a}_{t - L : t}^{h} = arg {max}_{{a}^{*} ∈ A} {\int }_{t - L}^{t} 𝕀 ( {a}_{t}^{h} = {a}^{*} ) d t , h ∈ \{ l , r \}$$

The tasks may be multi-labeled since some may be nearly indistinguishable from one another in the early stages of assembly. For instance, the Bridge, Arch, and Horse may appear identical when only the first two blocks are placed as may be seen in FIG. 2.

### Graph Neural Networks (GNNs)

GNNs may be a class of deep learning models designed to process and analyze structured data represented as graphs. Unlike traditional neural networks that operate on grid-like data structures (e.g., images or sequential data), GNNs may effectively capture complex relationships and dependencies among elements within a graph. A graph may be defined as G=(V,E), where V={v₁, v₂, . . . , v_{N}} may be a set of N nodes, and E={e₁, e₂, . . . , e_{M}} may represent the M edges connecting them. Nodes may correspond to various entities (e.g., objects, sensors, or robots), while edges may represent interactions or relationships between these entities. To represent the graph in matrix form, an adjacency matrix A∈R^{N×N} may be used, where each element A_{i,j} may indicate the relationship strength (or weight) between nodes vᵢ and vⱼ. Higher weights may signify stronger connections between node pairs.

GNNs may typically operate on undirected graphs, making the adjacency matrix A symmetric (A_{i,j}=Aj,ᵢ). GNNs may leverage graph structures to iteratively update node representations by aggregating information from neighbors. The learning process may consist of two steps: message passing and node aggregation. During message passing, each node may receive feature-based messages from its neighbors via edges, computed using a learnable weight matrix W through graph convolution. During the aggregation step, nodes update their features by summing or averaging received messages, followed by activation functions (e.g., rectified linear unit (ReLU)) to capture nonlinear relationships. This process may repeat over multiple graph convolutional layers, allowing nodes to integrate both local and global information for richer feature representations.

### Deep Dynamic Graph (DDG) Network

The Deep Dynamic Graph (DDG) network may initially employ a three-layer deep convolutional encoder, adapted from the Human Activity Recognition Transformer (HAR-Transformer), incorporating Time Absolute Position Encoding (tAPE) positional encoding to extract temporal features from each of the seven object entities (i.e., two hands and five blocks). The outputs of these convolutional encoders may be flattened into seven 32-dimensional embeddings, which may serve as input node features for a graph G. Intention estimation may be modeled as a function of spatial relationships among entities the operator interacts with, evolving over time. To capture this, we define the graph G with seven nodes, V={vₗ, vᵣ, v_{b1}, . . . , v_{b5}}, where vl and vr may represent the robots' end-effector hands, and v_{bi} may denote the five blocks manipulated during the task. The corresponding adjacency matrix Aₜ is dynamic, and may evolve as the task progresses. There may be two approaches for constructing Aₜ:

### Heuristic—Deep Dynamic Graph Network (H-DDG):

The adjacency matrix

$${A}_{t}^{D}$$

may be predefined using heuristics and structured as a symmetric binary matrix. Non-diagonal elements may be 1, if objects i and j, are in contact, otherwise 0. The diagonal elements for block nodes (v_{bi}) may be 1 if the block bi has been manipulated by either hand at least once, otherwise 0. Additionally, the diagonal values of the lefthand (vₗ) and the right-hand (vᵣ) nodes may be set to 1.

$${A}_{{t}_{i , j}}^{D} = \{ \begin{matrix}C ( i , j , t ) , & if i \neq j \\ C ( i , l , t ) \vert \vert C ( i , r , t ) , & if i = j ; i ∉ \{ l , r \} \\ 1 , & if i = j ; i ∈ \{ l , r \}\end{matrix} \qquad ( 1 )$$

$$C ( i , j , t ) = 𝕀 ( {\int }_{0}^{t} δ ( i , j , τ ) d τ ) , \qquad ( 2 )$$

where δ(i, j, τ) may be a contact indicator function that may be 1 if the objects (i, j) may be in contact at time τ, and 0 otherwise. The ∫ in Eqn. 2 may sum the contact occurrences over the interval [0, t]. The indicator function ∥(·) may return 1 if the ∫ is >0 (i.e., contact occurred at least once), and 0 otherwise.

### Learned—Deep Dynamic Graph Network (L-DDG):

The adjacency matrix

$${A}_{t}^{L}$$

may be parameterized as weighted connections, determined by applying a self-attention layer to the input node features. The attention scores may be normalized and converted into a symmetric matrix by averaging them with its transpose.

$$Attn ( Q , K , V ) = softmax ( \frac{{QK}^{T}}{\sqrt{{d}_{k}}} ) \qquad ( 3 )$$

$$softmax ( {x}_{i} ) = \frac{{e}^{{x}_{i}}}{\sum {e}^{{x}_{i}}}$$

$${A}_{t}^{L} = ( Attn + {Attn}^{T} ) / 2 ,$$

where Q (Query), K (Key), and V (Value) may represent the input node features, while dₖ may denote the dimensionality of these features. The dot product QK^{T} may compute the attention scores, which may then be scaled by

$$\frac{1}{√ dk}$$

and normalized using the softmax (·) function. The attention mechanism, and consequently the adjacency matrix

$${A}_{t}^{L} ,$$

may be learned end-to-end, enabling the network to identify spatial relationships among the entities autonomously.

### Model Architecture:

Both, H-DDG and L-DDG, networks may extract the spatial features from the nodes by repeatedly applying graph convolutional filters over multiple layers to estimate the operator's intention. A typical GNN may contain K graph filtering layers with K−1 activation layers. The graph filtering and activation at the k^{th} layer may be denoted as fₖ(·) and αₖ(·), respectively. This learning process may be denoted as:

$${Z}_{t}^{( k )} = {f}_{k} ( {A}_{t}^{P} , {F}_{t}^{( k - 1 )} ) , P ∈ \{ D , L \} \qquad ( 4 )$$

$${Z}_{t}^{( k )} = {A}_{t}^{P} * {F}_{t}^{( k - 1 )} * {W}^{( k - 1 )}$$

$${F}_{t}^{( k )} = {α}_{k} ( {Z}_{t}^{( k )} ) ,$$

where

$${A}_{t}^{P} ∈ {R}^{N \times N}$$

may denote the adjacency matrix, N=7 may be the number of nodes in the graph G. The operator ƒ(·) may be the graph convolutional filter that takes the F^{(k-1)}∈R^{N×dk-1} node feature and graph structure

$${A}_{t}^{P}$$

as input, and outputs the new node feature

$${Z}_{t}^{( k )} ∈ {R}^{N \times dk}$$

at each layer. The parameter W^{(k)}∈R^{dk×dk+1} may be the weight matrix learned at the k^{th} layer. F⁽⁰⁾∈R^{N×dvi} may be the H-DDG graph's input node feature layer.

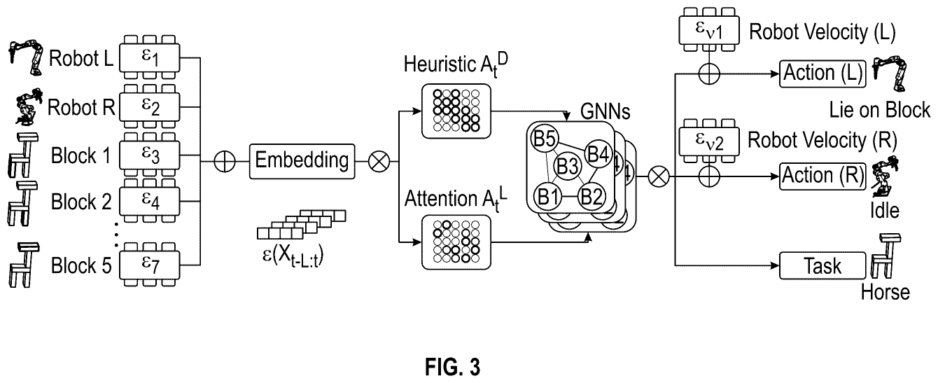

The final GNN layer F⁽²⁾ may be collapsed (i.e., flattened) and passed to a fully connected layer with 32 neurons with ReLU activation to form the GNN feature vector g_{vec}. This feature vector may be branched into three sub-layers to estimate:
i) task, ii) left-hand action, and iii) right-hand action, as may be illustrated in FIG. 3. The task layer may involve passing the decoded g_{vec} to an output sigmoid layer to predict multiple mutually non-exclusive tasks (i.e., multi-label classification), while each of the two action layers may involve passing the respective hand motion velocities' as input to a similar three-layer HAR-Transformer encoder, and combining the velocity features with the g_{vec} to estimate the actions.

$${ℒ}_{𝒞ℰ} = {ℒ}_{𝒯} + {ℒ}_{𝒜}^{l} + {ℒ}_{𝒜}^{r} \qquad ( 5 )$$

$${ℒ}_{𝒯} = - \frac{1}{N 𝒯} {\sum }_{i = 1}^{N} {\sum }_{r = 1}^{𝒯} {w}_{r} [ {y}_{i , τ} log {\hat{y}}_{i , τ} ]$$

$${ℒ}_{𝒜}^{h} = - \frac{1}{N} {\sum }_{i = 1}^{N} {( 1 - {\hat{y}}_{i} )}^{γ} {y}_{i} log {\hat{y}}_{i} , h ∈ \{ l , r \}$$

The networks may be trained to minimize a composite loss function L_{CE}, which may be a summation of the tasks' weighted binary cross-entropy loss, and the left and right hand actions' focal loss. The ADAM optimizer with a learning rate of 0.001 may be used to train the algorithm. Focal loss and binary cross-entropy with class weights (inversely proportional to class frequencies) may be employed to emphasize difficult to classify samples, addressing the inherent imbalance in the distribution of actions and tasks. A sliding window of t_{W}=3s with a stride of t_{S}=1s and a sampling rate of 20 Hz may segment the input motion features, which may ensure sufficient context for both task and action recognition. Additionally, motion features may be normalized to maintain consistency and equal treatment within the neural network.

Experimental setup: One may gather manipulation sequences of human users performing block assembly tasks by teleoperating a bi-manual robotic system on a virtual reality setup in a simulation environment. The users may perform eight block assembly tasks in a virtual scene rendered via Rviz, a 3D visualization tool within the Robot Operating System (ROS). This may be displayed in the HTC Vive Pro Eye headset, featuring a 1440×1600 pixels screen per eye with 110 degrees of field-of-view. The virtual scene may consist of a table with five identical wooden block assembly pieces.

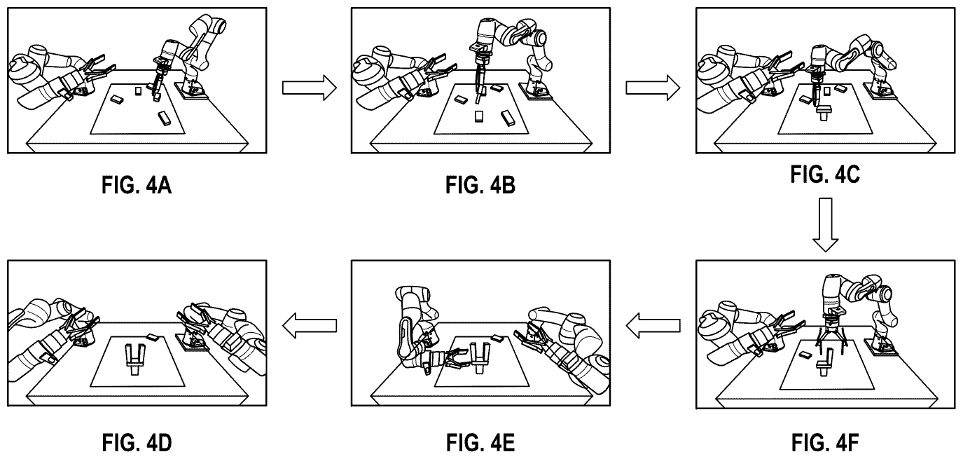

Dataset collection: One may collect data from 19 participants performing the different block assembly tasks, as may be shown in FIG. 4. There may be nine actions that the participants performed to accomplish the assembly tasks, defined based on the end-effector movements: Idle, Pick-up, Withdraw, Stand, Lie, Side-lie, Stand-on-block (Stand-OB), Lie-on-block (Lie-OB), and Side-lie-on-block (Side-lie-OB). Each teleoperated demonstration may require completing one entire task by executing the action sequences in any order chosen by the participant. The blocks' initial position and orientation may be randomized before the start of each demonstration. The left and right actions may be labeled separately based on their start and end times, while the tasks were multi-labeled, as some tasks may overlap with others, either partially or fully. For example, the Arch task overlaps with the Bridge and Horse tasks as may be seen in FIG. 2. The dataset may include 495 teleoperation demonstrations of eight block assembly tasks for a total of 480.4 minutes, during which the 7-DOF pose of the five wooden blocks in the workspace, the end effector pose, and egocentric video frames of the teleoperators may be recorded.

Baselines: The developed DDG networks may be benchmarked against three baselines: i) Naive CNN architecture, a three-layered 1-D convolutional network, ii) Hierarchical InEs, and iii) State-of-the-art HAR-Transformer. The latter two models may be adapted appropriately.

Evaluation: The intention algorithms may be validated using the leave-one-subject-out cross-validation scheme, where the mean F1-score may be reported by training the algorithms repeatedly on all, but one participant's data and validated using the left-out participant's data. The algorithms' classification F1-score may be the primary metric for assessing the performance, while the confusion matrices may compare the algorithms' misclassifications by tasks and actions.

The F1 classification scores in Table I may show that both DDG models outperform the naive CNN and hierarchical baselines, while performing on par with the state-of-the-art HAR-Transformer in terms of task prediction. Both L-DDG and H-DDG models may exceed the state-of-the-art in action prediction. Additionally, a consistent trend may be observed across all algorithms, where left-hand prediction F1 scores may be 2-4% higher than right-hand scores. This discrepancy may be due to most participants being right-handed, resulting in less frequent left-hand usage. This imbalance may skew the left-hand action classes toward the Idle action, which may arguably be the easiest action to predict. Furthermore, the task prediction scores may consistently exceed corresponding action prediction scores, which may suggest that short-horizon intention prediction may be more challenging due to its transient and dynamic nature.

TABLE I
Comparison of F1-scores % mean (std. dev.) between baseline
models and the proposed approach. The first and second highest
scores are highlighted in red and bold, respectively.

| | F1 score (%) | | |
|---|---|---|---|
| Model | Action (L) | Action (R) | Task |
| Naive CNN | 73.53 (6.40) | 72.34 (5.61) | 77.58 (4.38) |
| Hierarchical InEs | 43.97 (10.97) | 38.93 (8.90) | 49.43 (8.62) |
| HAR-Transformer | 81.49 (4.55) | 79.95 (4.39) | 90.12 (3.71) |
| H-DDG | 85.35 (3.46) | 83.75 (3.29) | 89.14 (3.49) |
| L-DDG | 81.73 (4.47) | 80.48 (4.84) | 89.82 (3.75) |

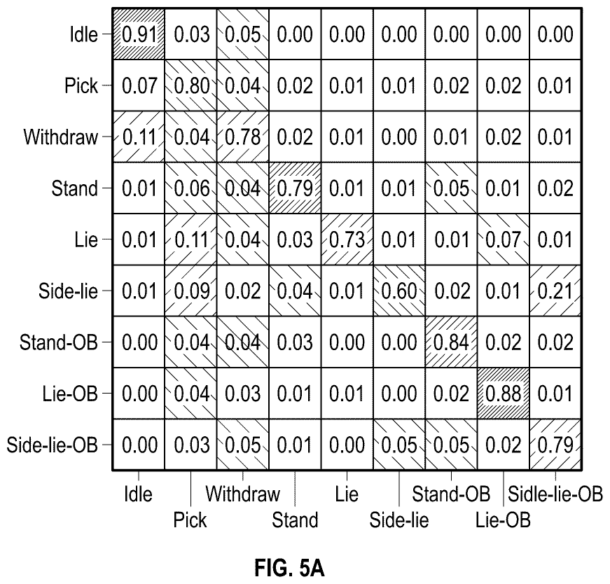

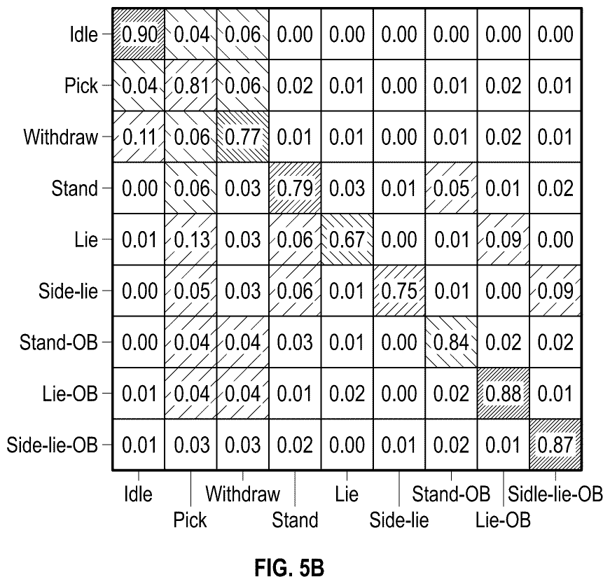

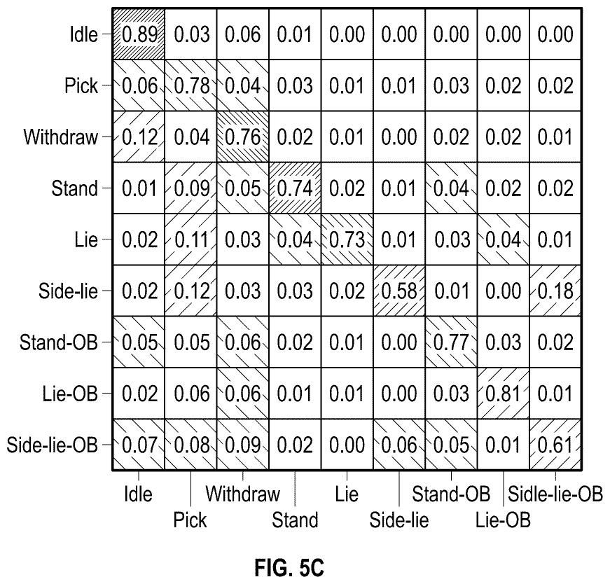

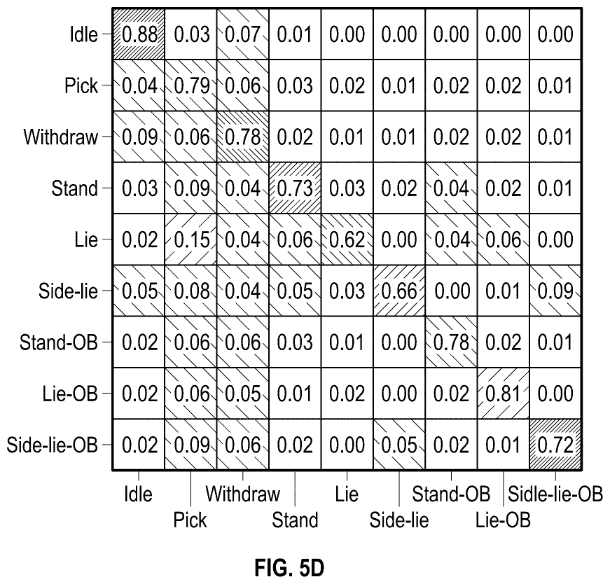

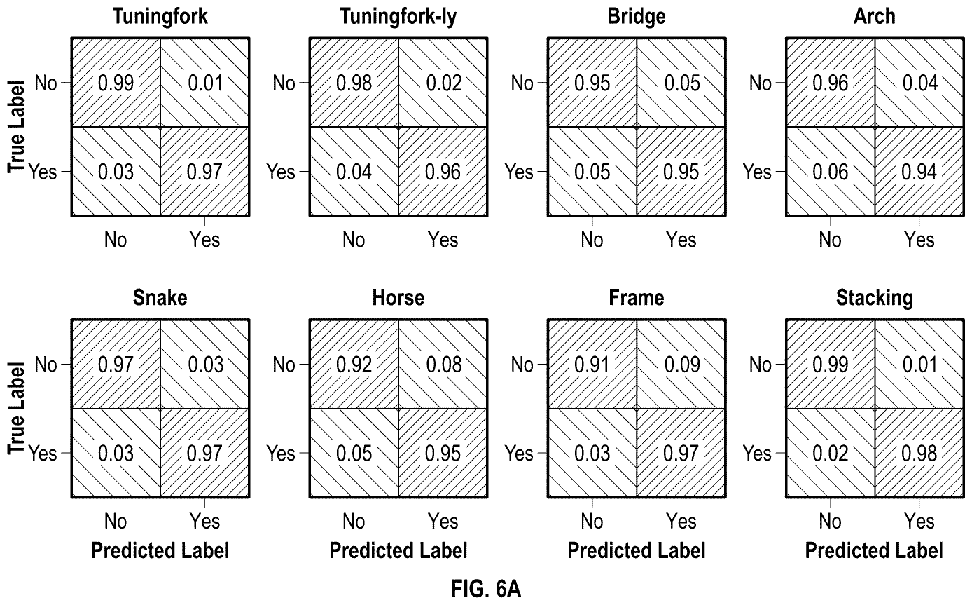

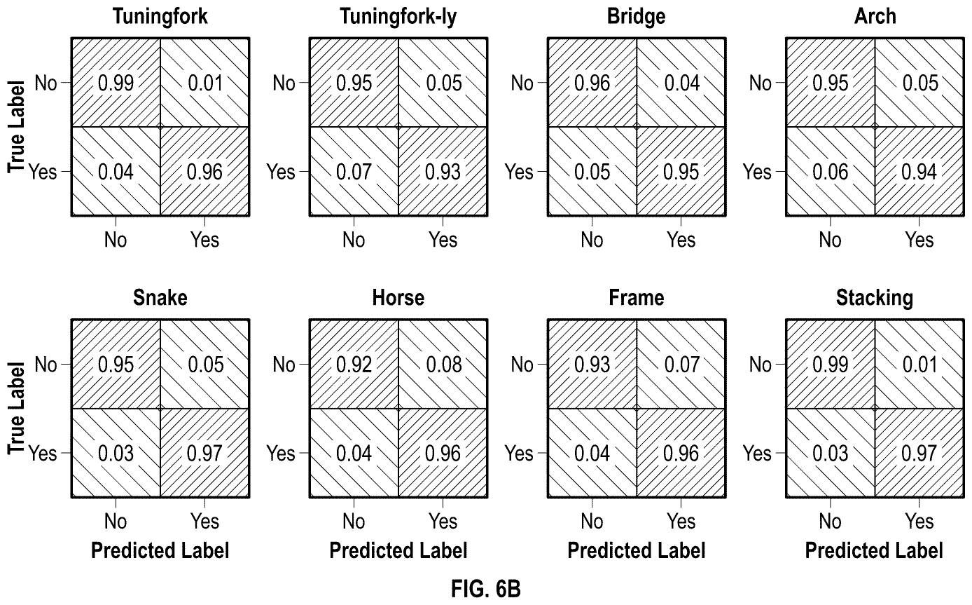

Referring to FIGS. 5A-5D, one may compare the action prediction confusion matrices. The matrices may reveal that the H-DDG model had the fewest action misclassifications, followed by the L-DDG model. The most misclassifications may occur with the Pick action, as it may frequently serve as a pre- and post-cursor for other actions. The Side-lie action may have the lowest accuracy, which may often be confused with Side-lie-OB, a similar action where a block is placed along its long edge on another block rather than on the table. This effect, which may be known as interclass similarity, may be observed among other action classes. All three algorithms may detect a task's presence and reject its absence with high accuracy (>90%) across all block assemblies as may be shown in FIGS. 6A-6B.

Overall, the H-DDG algorithm may demonstrate the best over-all classification performance, while the L-DDG may perform comparably to the HAR-Transformer model. However, a key drawback of the H-DDG model may be its reliance on domain knowledge to dynamically construct the graph for efficient message passing. Conversely, the L-DDG's data-driven approach may leverage the attention mechanism to learn the graph autonomously, eliminating this dependency and providing greater flexibility and task agnosticity. However, it may be important to ensure that the spatial relationships learned by the model may be explainable, consistent, and logically sound.

One may adopt a functionally-grounded evaluation method that may use computational proxies to measure interpretability in a scalable and cost-efficient manner. Additionally, a separate model, L-DDG (position Only), may be trained to estimate the actions and tasks, but using only the 3D position data as input. While this may reduce the prediction performance, it may be easier to interpret the model, as positional data is more intuitive than orientation. The L-DDG model's explainability may be assessed using three explainable metrics, each metric addressing a distinct aspect of the graph generated by the model:
Correctness: One may perturb the input features sequentially, following the explanation's order, and measure the resulting change in the model's output for each modified input.
Continuity: One may quantify the similarity among slightly different models, ensuring that small variations in the model or input samples do not lead to significant changes in the explanation.
Consistency: One may evaluate whether the explanation method remains invariant for specific tasks or can be generalized across different tasks.

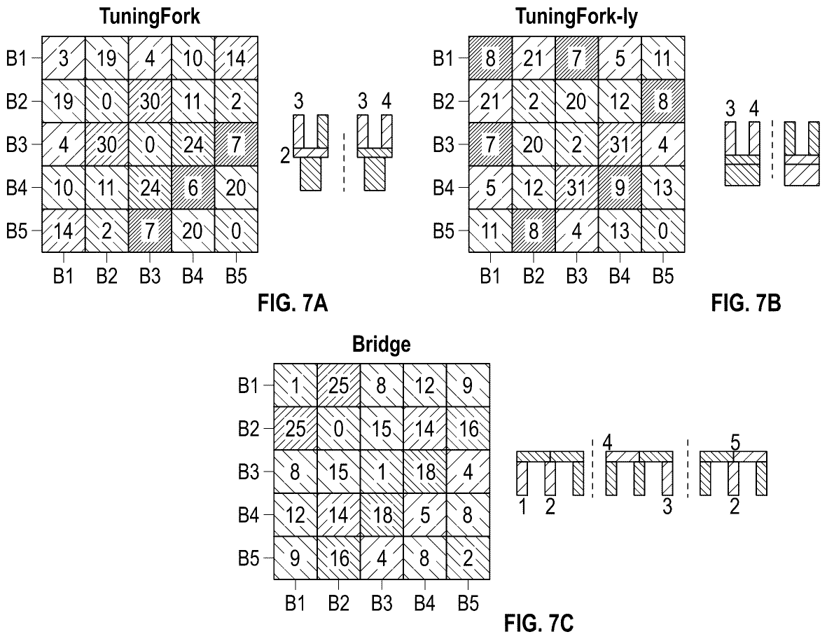

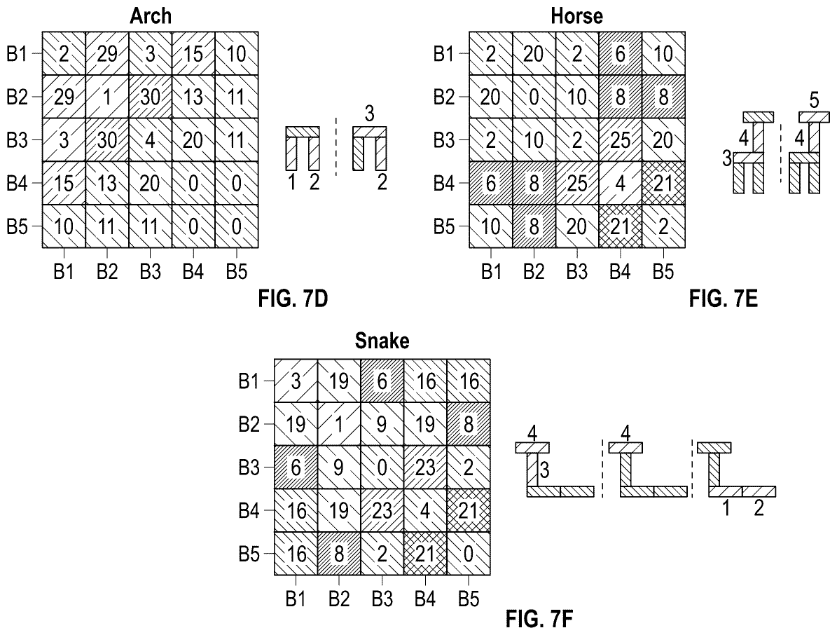

One may start by showcasing visual examples extracted from the learned graph generated by L-DDG, then proceed to evaluate its interpretability. FIGS. 7A-7C may display key block relationships, with the frequency adjacency matrix on the left and the task-specific importance relationships (highlighted by hatching) on the right. Frequency adjacency matrices may be built by ranking the learned attention maps during testing. For each task, the L-DDG graph's block connections at the trial's final timepoint may be ranked by attention scores, and the top three connections may be cumulatively added to form the matrix.

It may be hypothesized that these frequencies may indicate the importance of block connections for task estimation, referred to as “anchor connections.” Interestingly, these “anchor connections” may capture the spatial and geometrical dependencies inherent in the assembly process, thereby facilitating the identification of independent substructures. For instance, FIGS. 7A-7F may presents several distinctive “L” and “T” shapes identified by L-DDG for the “Arch” and “Horse” tasks, respectively. These patterns are consistent with the expected physical characteristics of the tasks.

Correctness: The correctness property may quantify how accurately the explanation reflects the predictive model's behavior. To assess this, anchor connections may be perturbed based on their ranked significance. After generating the frequency adjacency matrix for each task, the connections may be divided into five groups-Group 1 being the most frequent and Group 5 the least- and then sequentially removed from the L-DDG learned graph during inference.

Removing the most frequent connections (Groups 1 and 2) may cause an average performance drop of 2.15%, while removing the least frequent (Group 5) may reduce performance by less than 0.4% as may be shown below in Table II. Dropping the first group led to the largest decrease in performance, whereas dropping the fifth group yielded performance nearly identical to the original graph without any deletion. This observation may support the hypothesis that the graph connections may explain the model's ability to predict actions and tasks accurately.

TABLE II
Correctness of the learned anchor connections by graph edge deletion
across tasks (grouped by the order of significance). The lowest
and highest F1-score for each task is highlighted in red and
blue, respectively. The Reference column refers to the classification
score without any graph connection deletion.

| | F1-score (%) | | | | | |
|---|---|---|---|---|---|---|
| | Group | Group | Group | Group | Group | Refer- |
| Tasks | 1 | 2 | 3 | 4 | 5 | ence |
| Tuningfork | 91.70 | 94.78 | 95.68 | 95.39 | 96.00 | 96.69 |
| Tuningfork-ly | 73.08 | 78.67 | 78.29 | 78.26 | 78.55 | 78.29 |
| Bridge | 64.55 | 64.06 | 66.17 | 65.02 | 66.33 | 65.02 |
| Arch | 92.92 | 94.46 | 93.61 | 94.60 | 95.23 | 95.35 |
| Snake | 60.74 | 60.87 | 61.04 | 61.00 | 61.19 | 61.19 |
| Horse | 81.85 | 89.63 | 93.19 | 89.89 | 88.39 | 89.55 |
| Frame | 66.87 | 66.45 | 66.26 | 66.26 | 66.26 | 65.65 |
| Stacking | 71.48 | 78.43 | 75.29 | 70.04 | 71.32 | 71.27 |

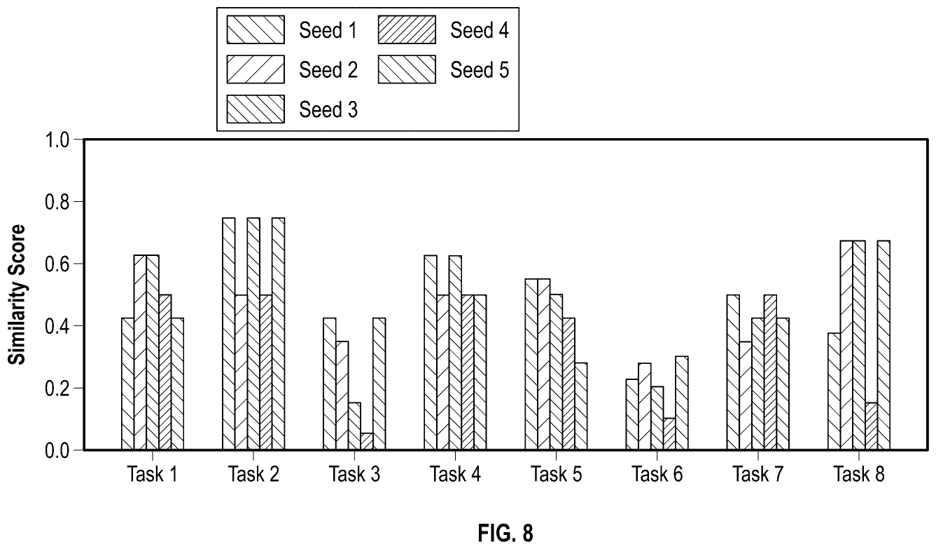

Continuity: This metric may measure the smoothness of the learned explanation, where small changes to the input may lead to nearly the same convergence. To evaluate this, one may train the L-DDG (positionOnly) model using five different seeds and compared the anchor connections produced by each seed across all tasks by measuring the Jaccard similarity index. FIG. 8 may display the similarity results, where each score may be computed as the average similarity of one seed compared to the other four. A similarity score of 1 may indicate that the top three anchor connections may be identical across all seeds, and given that the top two anchor connections may dominate the frequency counts, a score≥0.5 may be considered high. Notably, all seeds, except seed 4, may reveal similar anchor connections for most tasks—particularly in the TuningFork, TuningFork-ly, and Arch tasks, which may prominently feature “II” and “L” shapes across seeds. This may confirm the continuity of L-DDG explainability.

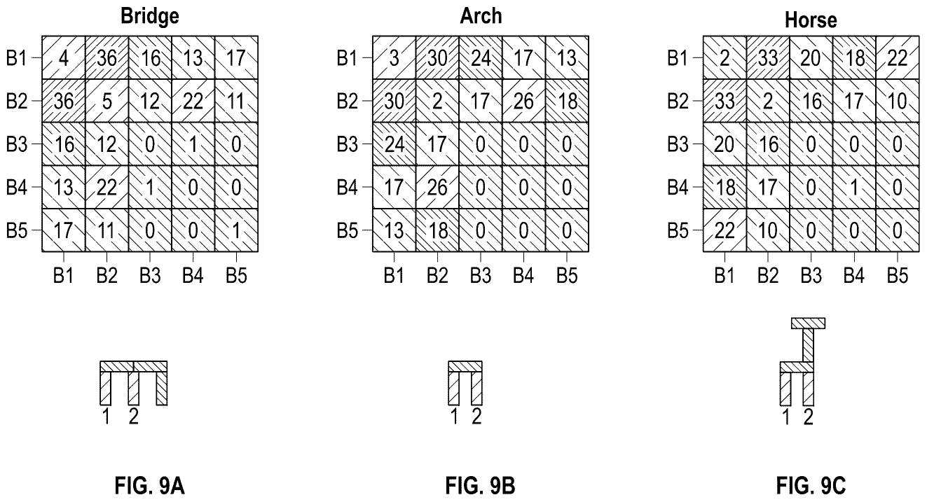

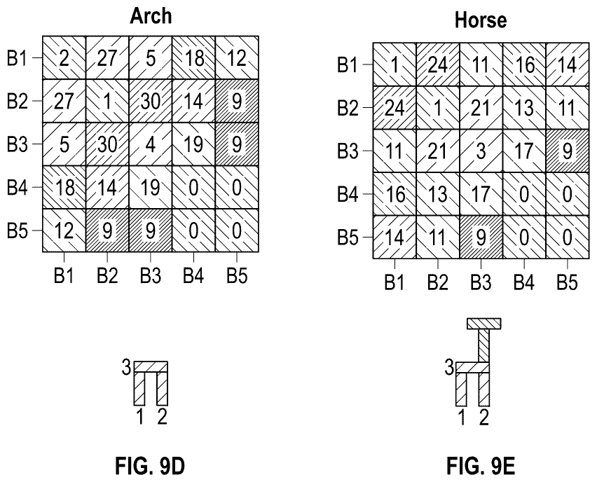

Consistency: This metric may measure the extent to which an explanation method is deterministic-if a model produces the same output, it should also yield identical explanations. FIGS. 7A-7F may demonstrated the consistency of the learned explanations by statistically calculating the frequency of anchor connections for each predicted task. In this section, L-DDG's consistency over time may be demonstrated using Bridge, Arch, and Horse tasks, each featuring “II” and “n” sub-topologies. Even with only two or three blocks, the same predicted task label may correspond to identical learned anchor connections, as shown in FIGS. 9A-9E. The frequency adjacency matrix (top row) and the learned anchor connections (bottom row) may reveal that even with an incomplete assembly, L-DDG captures the “II” and “n” sub-topologies, as evidenced by the results during the construction of a horse.

Shared autonomy may be vital for teleoperating robotic systems in complex manufacturing and assembly tasks. A seamless collaboration and trust in shared autonomy may rely on the robot's ability to interpret human intentions consistently and transparently. The developed DDG networks may address this challenge by predicting human intention at two hierarchical levels, and generating logically grounded graphs that may be empirically verified to be consistent and interpretable. These graphs may encapsulate dynamic spatial relationships, which can be leveraged for various downstream teleoperation processes.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for intention estimation in robot teleoperation tasks comprising:
generating dynamic graphs that show spatial relationships over time to predict user intentions for short-horizontal actions and long-horizon tasks.

2. The method of claim 1, wherein generating dynamic graphs comprises forming the dynamic graphs using a heuristic graph neural network (GNN) to model dynamic spatial object relationships between objects using pre-defined rules.

3. The method of claim 2, wherein generating dynamic graphs comprises generating the spatial relationships for long-horizon tasks using a learned graph neural network (GNN).

4. The method of claim 1, comprising evaluating learned spatial relationships of the dynamic graphs using empirical and anecdotal data.

5. The method of claim 1, comprising:
encoding end effector data of a robot performing the teleoperation tasks and object poses of the teleoperation tasks; and
processing the end effector data and object poses by graph neural networks (GNNs) to generate the dynamic graphs.

6. The method of claim 5, wherein the end effector data and the object poses are encoded separately.

7. The method of claim 1, comprising:
recording end effector data of a robot performing the teleoperation tasks and object poses of the teleoperation tasks;
applying a predetermined fixed size window on the end effector data and object poses to segment the end effector data and object poses into end effector data and object poses of a current predetermined timeframe;
encoding the end effector data and object poses of the current predetermined timeframe;
processing the end effector data and object poses of the current predetermined timeframe by graph neural networks (GNNs) to generate the dynamic graphs.

8. The method of claim 7, comprising partitioning learned features from the dynamic graphs into multiple channels for the intention estimation.

9. The method of claim 7, comprising partitioning learned features from the dynamic graphs into three channels for intention estimation of a left arm action of the robot, a right arm action of the robot and a task to be performed.

10. The method of claim 7, wherein processing the end effector data and object poses of the current predetermined timeframe by graph neural networks (GNNs) to generate the dynamic graphs comprises:
generating a plurality of input nodes based on the end effector data and object poses of the current predetermined timeframe and edges representing interactions between the input nodes to form the dynamic graphs; and
generating an adjacency matrix wherein each element in the adjacency matrix indicates a weighted value between a corresponding pair of input nodes, wherein higher weighted values indicate stronger connections.

11. The method of claim 10, comprising:
updating the weighted values between the pair of input nodes by message passing, wherein each input node receives data from adjacent input nodes through the edges, computed using a learnable weight matrix W through graph convolution; and
updating the weighted values between the pair of input nodes node aggregation, wherein each input node updates data by one of summing or averaging received messages, followed by activation functions to capture nonlinear relationships.

12. The method of claim 10, comprising:
updating the weighted values between the pair of input nodes by message passing, wherein each input node receives data from adjacent input nodes through the edges, computed using a learnable weight matrix W through graph convolution;
updating the weighted values between the pair of input nodes by node aggregation, wherein each input node updates data by one of summing or averaging received messages, followed by activation functions to capture nonlinear relationships; and
repeating updating the weighted values between the pair of input nodes by message passing and by node aggregation for a plurality of layers.

13. The method of claim 10, wherein the adjacency matrix is formed using a heuristic deep dynamic graph network (H-DDG).

14. The method of claim 10, wherein the adjacency matrix is formed using a learned deep dynamic graph network (L-DDG).

15. A method for intention estimation in robot teleoperation tasks comprising:
encoding end effector data of a robot performing the teleoperation tasks and object poses of the teleoperation tasks; and
generating dynamic graphs by processing the end effector data and object poses to show spatial relationships over time to predict user intentions for short-horizontal actions of a next step and long-horizon task of multiple steps/actions in a specific order over a predetermined period to reach a predetermined objective using a heuristic graph neural network (GNN) to model dynamic spatial object relationships between objects using pre-defined rules and using a learned GNN for generating the spatial relationships for long-horizon tasks.

16. The method of claim 15, wherein the end effector data and the object poses are encoded separately.

17. The method of claim 15, comprising:
applying a predetermined fixed size window on the end effector data and object poses to segment the end effector data and object poses into end effector data and object poses of a current predetermined timeframe;
encoding the end effector data and object poses of the current predetermined timeframe;
processing the end effector data and object poses of the current predetermined timeframe by the heuristic GNN and the learned GNN to generate the dynamic graphs.

18. The method of claim 17, comprising partitioning learned features from the dynamic graphs into multiple channels for the intention estimation.

19. The method of claim 17, wherein generating the dynamic graphs comprises:
generating a plurality of input nodes based on the end effector data and object poses of the current predetermined timeframe and edges representing interactions between the input nodes to form the dynamic graphs; and
generating an adjacency matrix wherein each element in the adjacency matrix indicates a weighted value between a corresponding pair of input nodes, wherein higher weighted values indicate stronger connections;
updating the weighted values between the pair of input nodes by message passing, wherein each input node receives data from adjacent input nodes through the edges, computed using a learnable weight matrix W through graph convolution;
updating the weighted values between the pair of input nodes node aggregation, wherein each input node updates data by one of summing or averaging received messages, followed by activation functions to capture nonlinear relationships; and
repeating updating the weighted values between the pair of input nodes by message passing and by node aggregation for a plurality of layers.

20. A method for intention estimation in robot teleoperation tasks, the method implemented using a computer system including a processor communicatively coupled to a memory device, the method comprising:
encoding end effector data of a robot performing the teleoperation tasks and object poses of the teleoperation tasks;
processing the end effector data and object poses by graph neural networks (GNNs) generating dynamic graphs that show spatial relationships over time to predict user intentions for short-horizontal actions and long-horizon tasks, wherein the end effector data and the object poses are encoded separately; and
partitioning learned features from the dynamic graphs into multiple channels for the intention estimation.
